(19) United States
(12) Patent Application Publication
(10) Pub. No.: US 2014/0326907 A1
(43) Pub. Date: Nov. 6, 2014

(54) SOLENOID-CONTROLLED SLIDING INTAKE AND EXHAUST VALVES FOR INTERNAL COMBUSTION ENGINES

(71) Applicant: Jack R. TAYLOR, Maineville, OH (US)

(72) Inventor: Jack R. TAYLOR, Maineville, OH (US)

(21) Appl. No.: 14/331,588

(22) Filed: Jul. 15, 2014

Related U.S. Application Data
(62) Division of application No. 13/972,980, filed on Aug. 22, 2013.
(60) Provisional application No. 61/691,842, filed on Aug. 22, 2012.
(60) Provisional application No. 61/691,843, filed on Aug. 22, 2012.

(51) Int. Cl. F16K 31/06; F02M 63/00

(52) U.S. Cl. CPC F16K 31/0675; F02M 63/0017
USPC 251/129.2

(57) ABSTRACT

A solenoid-operated air inlet or combustion exhaust valve, for a rotary exhaust valve assembly or a sliding plate valve. The rotary exhaust valve has a fixed housing with a cylindrical bore in fluid communication with an air inlet port and/or a combustion gas outlet port, and a cylindrical valve body that rotates within the bore of the fixed housing. The valve body has a gas passage transverse to the axis. The sliding plate valve has a fixed housing with a cylindrical bore in fluid communication with a gas inlet passage and a gas outlet passage, and a plate between the gas inlet passage and the gas outlet passage with an aperture, moving between open and closed positions. An electric linear solenoid reciprocates linearly and operates the sliding plate valve or the rotary valve, directly or through a lever to rotate the rotary valve body, between the open and closed positions.

### CROSS-REFERENCE TO RELATED APPLICATIONS

This application is a continuation of U.S. application Ser. No. 13/972,980, filed Aug. 22, 2013, which claims the benefit of U.S. provisional patent application 61/691,842, filed Aug. 22, 2012, and of U.S. provisional patent application 61/691,843, filed Aug. 22, 2012, the disclosures of which are incorporated by reference in their entirety.

### FIELD OF THE INVENTION

The present invention is in the field of internal combustion (IC) engines, and more particularly high efficiency IC engines, and to intake and exhaust valves therefore.

### BACKGROUND OF THE INVENTION

Conventional poppet valves for IC engines have complex and costly camshafts and rocker arm mechanisms to open and close the intake and/or exhaust valves in timing with the reciprocating movement and position of the piston in the cylinder, and are subject to high heat stresses, leakage, and mechanical failure. Also, significant pressure losses in the exhaust gasses are caused by valve stem and valve guide blockages in the exhaust pipe.

The ability to have rapid and precise control of the opening and closing times for internal combustion engine exhaust and intake valves at different operating conditions can result in a significant improvement in engine efficiency. See, for example, U.S. Pat. No. 5,083,533, issued to Richeson et al., incorporated by reference in its entirety. Several automobile companies have developed complex mechanical systems to change the valve timing.

A high spring force is used to close the conventional poppet valve rapidly, and the combustion gas pressure force against the poppet valve is very high. Therefore, if a conventional electrical solenoid is used to open and close this valve, it would quickly overheat, because high electrical currents would be required at high engine speeds. Additionally, the high amount of energy required to control a conventional electric solenoid to open and close the poppet valve reduces engine efficiency.

### SUMMARY OF THE INVENTION

The present invention provides a solenoid-operated air inlet or combustion exhaust valve for an internal combustion (IC) engine. The solenoid-operated valve can be selected from a rotary exhaust valve assembly or a sliding plate valve.

The present invention also relates to a solenoid-operated rotary valve and its use as a gas valve assembly in an IC engine. The rotary valve includes a fixed housing having a cylindrical bore, the bore being in fluid communication with a gas inlet port and/or a gas outlet port, and a cylindrical valve body disposed rotatably within the bore of the fixed housing, the valve body having a passage transverse to the axis. The passage is sized in cross section to register with the gas inlet and outlet ports to minimize flow blockage and pressure loss. The valve body is rotated on its axis by an electronically-controlled solenoid between a position where the passage is aligned with the gas inlet port and the gas outlet port, deemed an “open” position, and a position where the passage is out of fluid communication with the gas inlet port and/or gas outlet port, deemed a “closed” position. In the closed position the cylindrical surface of the valve body is positioned across the gas inlet and/or gas outlet port, cutting off gas flow between the two ports.

The invention also relates to a rotary exhaust valve assembly for the combustion gas exhaust piping of an internal combustion engine, the rotary exhaust valve having a fixed housing with a cylindrical bore in fluid communication with a combustion gas inlet port and outlet port, and a cylindrical valve body that rotates within the bore of the fixed housing. The valve body has a gas passage transverse to the axis, and an electric linear solenoid that reciprocates linearly and operates a lever to rotate the valve body between an open position that allows exhaust gases to pass through the rotary valve, and a closed position that blocks combustion gas flow from the engine cylinder.

The valve body is rotated within the housing using a mechanical lever and linkage connected to an electrical solenoid. With sufficient lubrication and the use of low friction bearings for the shaft of the valve body, the force and cycle duty required for rotation by the electrical solenoid can avoid overheat. When the rotary valve is used in an exhaust pipe of an IC engine, the valve body outer wall is exposed to high combustion temperatures, which requires either that the interior of the valve body be cooled, or fabrication of the valve body from a heat resistant material, such as a ceramic matrix composite (CMC) material.

The invention also relates to a method of operating an internal combustion engine, comprising the steps of: a. providing a cylinder of an IC engine, b. providing a rotary exhaust valve including a cylindrical valve body having a transverse passage therethrough, the valve body rotatable between a first rotated position wherein the passage is in fluid communication with an inlet gas port and an outlet gas port, and a closed rotated position wherein the passage is not in fluid communication with the inlet gas port or the outlet gas port, c. providing an electric solenoid that operates between a powered position and an unpowered position, d. applying power for a portion of the engine cycle to the electric solenoid to operate the solenoid to its powered position, to effect rotation of the rotary exhaust valve to one of the first rotated position or the second rotated position, e. removing power for a portion of the engine cycle from the electric solenoid to operate the solenoid to its unpowered position, to effect rotation of the rotary exhaust valve to the other of the first rotated position or the second rotated position, and f. repeating steps d. and e.

The present invention provides a sliding plate valve apparatus for a gas intake or exhaust piping for a cylinder of an internal combustion engine, the sliding plate valve apparatus comprising: a plate having a cover portion, a fixed housing having a gas inlet port and a gas outlet port, and a plate cavity within which the plate can slide in a plane substantially perpendicular to the axes of the gas inlet and gas outlet ports, and an electric solenoid that reciprocates to move the plate within the housing between an open position wherein a portion of the plate does not cover the gas inlet port or the gas outlet port to provide fluid communication therebetween. The port is completely open with no restrictions to the flow. Also, in the closed position, the covering portion of the plate covers the gas inlet port, and/or the outlet port, completely.

The invention also relates to a method of operating an internal combustion engine, comprising the steps of: a. providing a cylinder of an IC engine, b. providing a sliding plate valve assembly described herein, c. providing an electric solenoid that operates between a powered position and an unpowered position, d. applying power for a portion of the engine cycle to the electric solenoid to operate the solenoid to its powered position, to effect movement of the sliding plate of the sliding plate valve assembly to one of an open position wherein a portion of the plate does not cover the gas inlet port or the gas outlet port, or a closed position wherein a portion of the plate covers the gas inlet port or the gas outlet port, e. removing power for a portion of the engine cycle from the electric solenoid to operate the solenoid to its unpowered position, to effect movement of the sliding plate to the other of the open position or the closed position, and f. repeating steps d. and e.

An electrical current is required by the solenoid for moving the plate between the opened position and the closed position, or rotating the rotary valve, typically under the control of a programmed computer. The operation of the sliding plate valve or rotary valve, to open and close, can be controlled to provide high engine efficiency at all engine speeds and operating conditions. Examples of systems for powering and controlling solenoid valves are described in U.S. Pat. Nos. 4,949,215 and 6,164,323, the disclosures of which are incorporated herein by reference. Examples of solenoids can include those described in U.S. Pat. No. 5,494,255, the disclosure of which is incorporated herein by reference.

For engine starting conditions with multiple cylinders, and high compression ratio engines, all of the exhaust valves can be held open until a cylinder fires and then the valves can be closed in firing order sequence until the engine is running. This would greatly reduce the power required to start the engine. An advantage of the rotary valve or the sliding plate valve apparatus is the elimination of the complex, costly, and heavy mechanism required for conventional poppet valves. The large, fully open flow path for the exhaust pipes will also reduce exhaust system pressure losses and increase the engine efficiency.

### DESCRIPTION OF THE DRAWINGS

FIG. 1 shows a sectional view an engine cylinder through the axial center of the cylinder and the gas outlet pipe, with a rotary exhaust valve assembly disposed between the gas inlet port and the gas outlet port, operated by a solenoid to a closed position.

FIG. 2 shows a sectional view through the axis of the exhaust pipe, along line 2-2 of FIG. 1.

FIG. 3 shows the sectional view the engine cylinder of FIG. 1, where the valve body of the rotary exhaust valve assembly is operated to an open position.

FIG. 4 shows a sectional view through the axis of the exhaust pipe, along line 4-4 of FIG. 3.

FIG. 5 shows an exploded schematic of the rotary exhaust valve.

FIG. 6 shows a view of the rotary exhaust valve with the valve body in the closed position, viewed along line 6-6 of FIG. 1.

FIG. 7 shows the rotary exhaust valve of FIG. 6 with the valve body in the open position.

FIG. 8 shows a sectional view of an engine cylinder through the axial center of the cylinder and the gas outlet pipe, with a sliding plate exhaust valve assembly disposed between the valve inlet gas pipe and the valve outlet gas pipe of the combustion exhaust port, operated by a solenoid to a closed position.

FIG. 9 shows a sectional view along the sliding plate exhaust valve, along line 9-9 of FIG. 8.

FIG. 10 shows the sectional view of the engine cylinder of FIG. 8, where the sliding plate exhaust valve assembly is operated to an open position.

FIG. 11 shows a sectional view along the sliding plate exhaust valve in the open position, along line 11-11 of FIG. 10.

FIG. 12 shows a sectional view through the sliding plate exhaust valve, along line 12-12 of FIG. 11.

FIG. 13 shows a sectional view of a contoured sliding plate valve with no aperture, in the closed position.

FIG. 14 shows the sectional view of the contoured sliding plate valve of FIG. 13, in the open position.

### DETAILED DESCRIPTION OF THE INVENTION

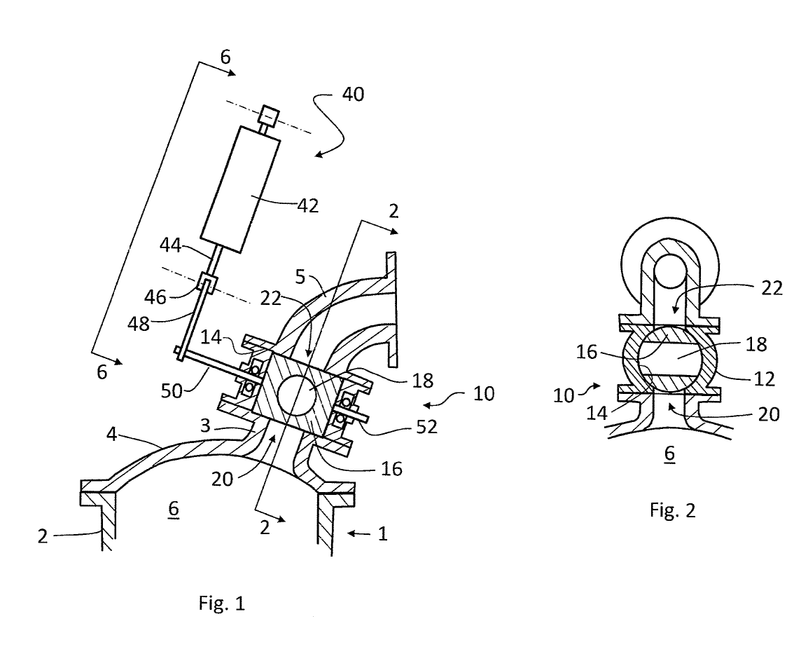

FIGS. 1-6 show a rotary valve and a rotary valve assembly for a cylinder of an internal combustion (IC) engine. The rotary valve and rotary valve assembly can be employed as an air inlet valve or as a combustion air exhaust valve.

The engine cylinder 1 includes a cylinder wall 2 and a head 4 that define a cylinder space 6. The rotary valve 10 is mounted to an inlet gas pipe 3 of the cylinder head 4 having a gas inlet passage 20, and to an outlet gas pipe 5 having a gas outlet passage 22.

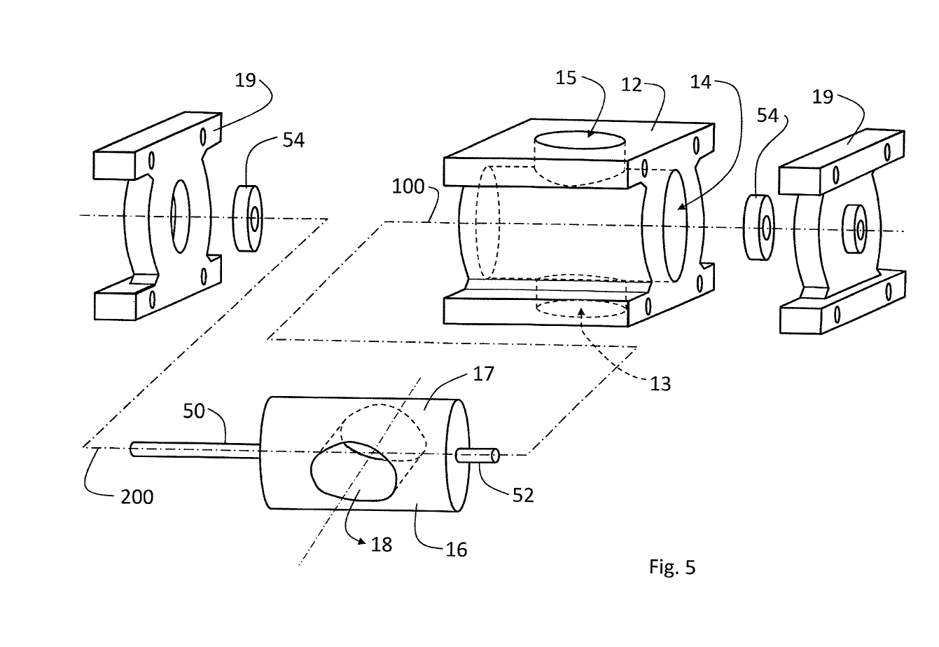

As shown in FIG. 5, the rotary valve 10 includes a fixed housing 12 having a cylindrical bore 14 arranged on an axis 100, an inlet port 13 intersecting bore 14 substantially perpendicularly, and an outlet port 15 intersecting bore 14 substantially perpendicularly, wherein bore 14 and inlet/outlet ports 13, 15 provide a fluid communication through the housing 12. The gas inlet passage 20 and the gas outlet passage 22 communicate fluidly with the inlet port 13 and the outlet port 15, respectively, which are preferably all formed in the same size and shape in cross section.

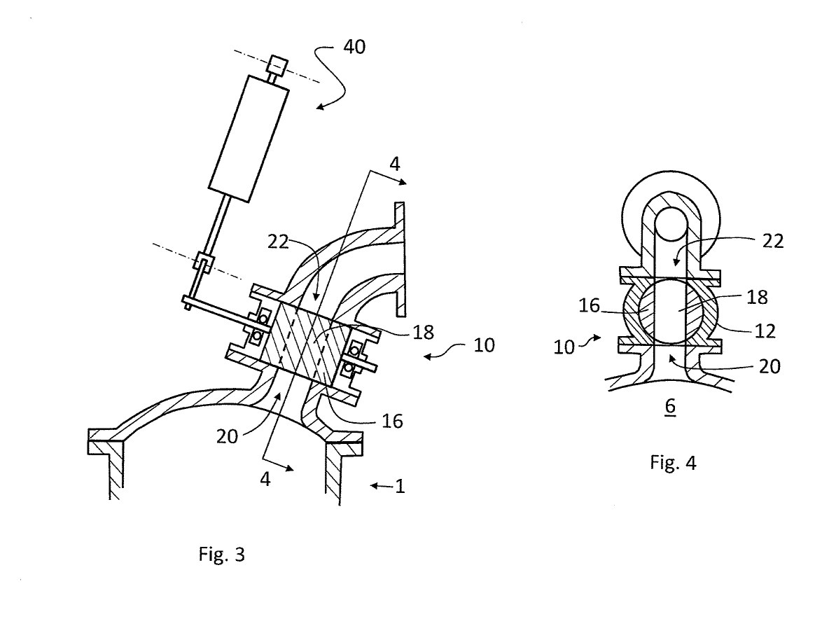

A cylindrical valve body 16 is disposed rotatably within the bore 14 of the fixed housing 12. The valve body 16 has a linear passage 18 passing therethrough, transverse to rotational axis 200. The passage 18 is sized in cross section to register with the inlet port 13 and outlet port 15, to minimize flow blockage and pressure loss of gasses passing through the valve. The valve body 16 is rotated by an electronically-controlled solenoid 42 between an open position shown in FIGS. 3 and 4 where the passage 18 is aligned with the inlet port 13 and the outlet port 15, and a closed position shown in FIGS. 1 and 2 where the passage 18 is out of fluid communication with the inlet port 13 and/or outlet port 15, deemed a “closed” position. In the closed position the cylindrical surface 17 of the valve body 16 is positioned across the inlet port 13 and/or outlet port 15, cutting off gas flow between the two ports.

The valve body 16 includes a proximal shaft 50 and a distal shaft 52 extending from respective ends, and is supported for rotation within the bore 14 of the housing 12 along proximal shaft 50 and distal shaft 52 with low friction bearings 54 fitted into end plates 19.

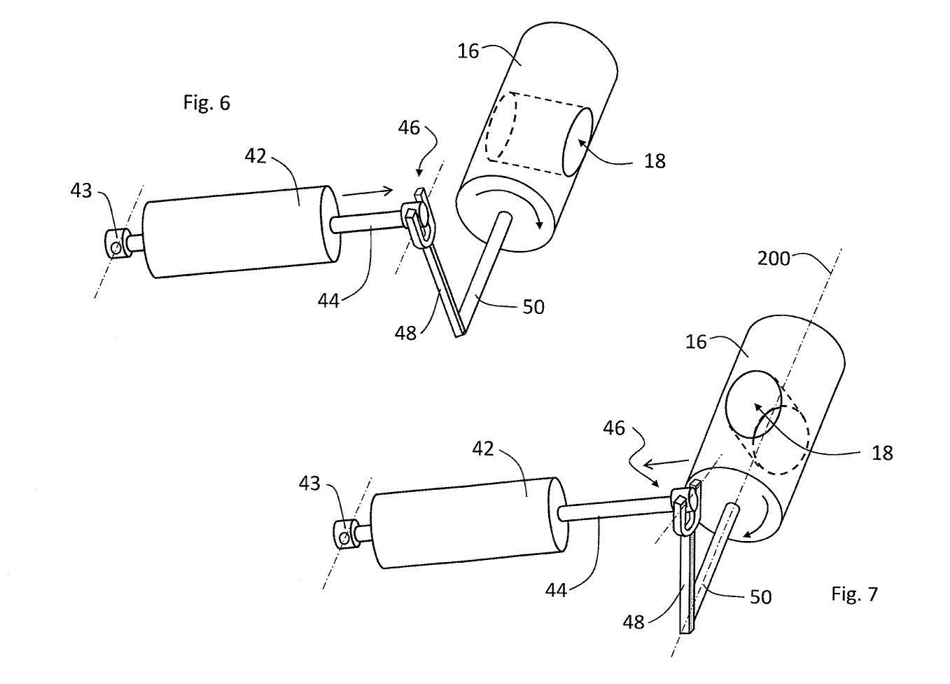

As shown in FIG. 6, the valve body 16 is rotated within the housing 12 using a mechanical lever 48 fixed at one end to the proximal shaft 50, and fixed at the opposite end to linkage 46. The proximal end of the solenoid 42 is fixed at pivot point 43, while the distal end of arm 44 is pivotally fixed to linkage 46. The valve body 16 is illustrated in the closed position. Extension of the arm 44 of the solenoid 42, shown in FIG. 7, effects rotation of the lever 48/shaft 50 about axis 200 rotating the rotary valve 16, delivering the valve body 16 to the open position.

The electric solenoid 42 can include a push-type or pull-type linear solenoid, substantially as shown in FIG. 6, or a rotary solenoid (not shown, but well known in the art). Examples of solenoids can include those described in US Patent 5,494,255, the disclosure of which is incorporated herein by reference.

Optionally, a separate return spring or other mechanical means of biasing the rotary valve to either the open position or the closed position can be employed, to optimize the power requirements of the solenoid or reduce the transition time for movement of the rotary valve between the open and closed positions.

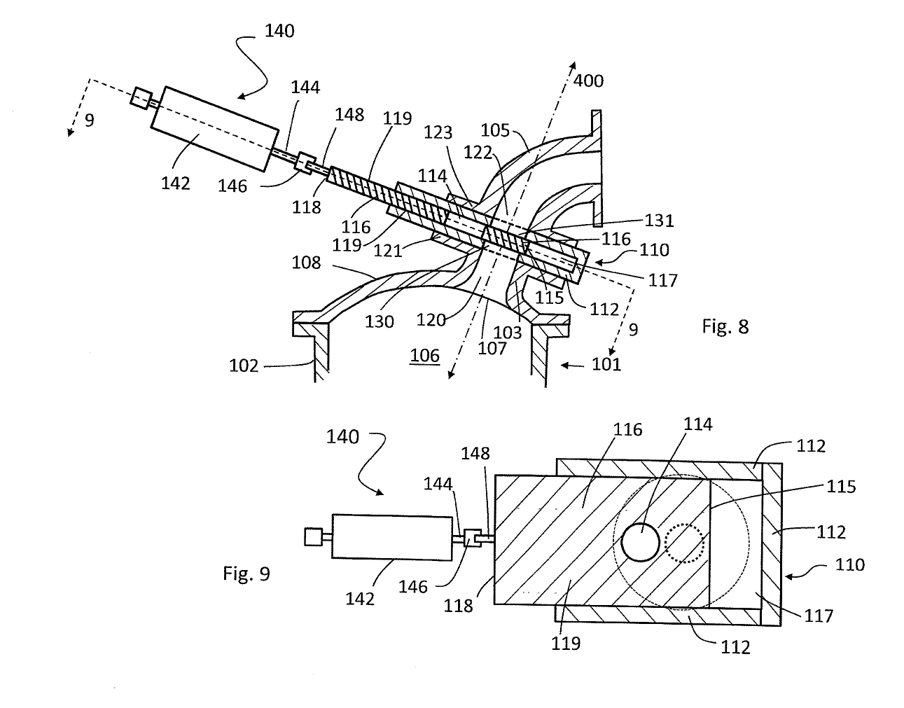

The present invention also provides a sliding plate valve assembly for a cylinder of an internal combustion (IC) engine. The sliding plate valve can be employed as an air inlet valve or as a combustion air exhaust valve or both. FIGS. 8-14 show the sliding plate valve employed as a combustion air exhaust valve, although the features and functions as an inlet air valve would be similar.

In FIGS. 8-11, the engine cylinder 101 includes a cylinder wall 102 and a cylinder head 108 that define a cylinder space 106. The sliding plate valve assembly 110 is mounted between a valve inlet gas pipe 103, connected to the cylinder head 108 at the combustion exhaust port 107. The valve inlet gas pipe 103 defines a valve inlet gas passage 120, and the valve outlet gas pipe 105 defines a valve outlet gas passage 122. The valve inlet gas passage 120 and the valve outlet gas passage 122 are aligned along axis 400. The valve inlet gas pipe 103 and the valve outlet gas pipe 105 may optionally have a valve inlet flange 121 and a valve outlet flange 123, respectively.

The sliding plate valve assembly 110 has a fixed housing 112, a plate 116, and a solenoid apparatus 140. The fixed housing 112 is attached to the valve inlet gas pipe 103 and the valve outlet gas pipe 105 by any mechanical attachment means, including but not limited to bolts, screws, welding and the like. If the valve inlet gas pipe 103 and the valve outlet gas pipe 105 have respectively a valve inlet flange 121 and a valve outlet flange 123, the fixed housing 112 is mechanically attached to the valve inlet flange 121 and valve outlet flange 123. The fixed housing 112 has a first fixed housing bore 130 and a second fixed housing bore 131 that is aligned with the valve inlet gas passage 120 and the valve outlet gas passage 122 along axis 400. The first fixed housing bore 130 and the second fixed housing bore 131 are typically the same cross dimensional sized circular shape as the valve inlet gas passage 120 and the valve outlet gas passage 122, to minimize flow blockage and pressure loss of gasses passing through the sliding plate valve assembly 110.

The fixed housing 112 has a plate cavity 117 substantially perpendicular to axis 400 of substantially rectangular shape, although the plate cavity 117 can be of any shape complementary to the plate 116. The plate cavity 117 is configured to allow the plate 116 to fit and slide laterally with little friction. The plate 116 is defined by plate faces 119 and plate end edges 115,118 to minimize clearance spacing. The plate cavity 117 in the fixed housing 112 has a cross section slightly larger and of the same shape as the plate front edge 115. While the plate 116 thickness, width and length can be of any dimensions, it is preferred that the plate be thin, narrow and short to reduce weight, and can have void or depression areas on either or both sides of the plate, and thus its inertia, when being moved by the solenoid apparatus 140. The fixed housing 112 can be constructed of multiple parts that are mechanically attached and define the plate cavity 117.

In one embodiment, the plate 116 has a plate bore 114 with an axis that is parallel to axis 400. The plate bore 114 is typically of the same size and shape as the first fixed housing bore 130 and second fixed housing bore 131, as to minimize flow blockage and pressure loss of gasses passing through the sliding plate valve assembly 110 in its “open” position aligned with the other passages.

The plate 116 is attached to a solenoid apparatus 140. The solenoid apparatus 140 is defined by an electronically controlled solenoid 142 and an arm 144. The solenoid arm 144 is mechanically attached via linkage 146 to a rod 148, and the rod 148 is attached to plate 116 at the plate back edge 118. Alternatively, the arm 144 can be connected directly to the plate back edge 118.

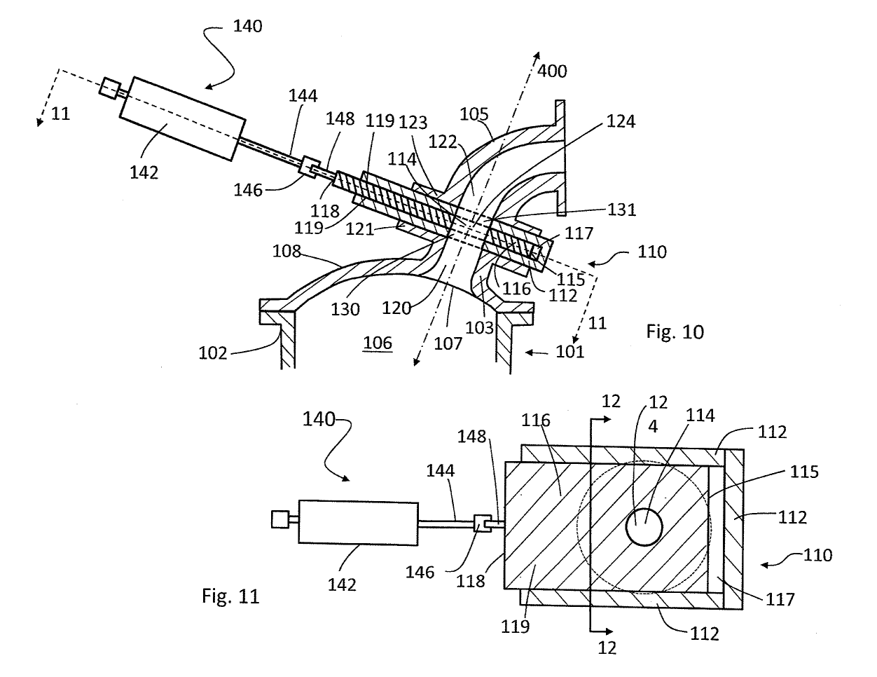

To operate the sliding plate valve assembly 110, an electric solenoid 142 slides the plate 116 between a position shown in FIGS. 8 and 9, where the plate bore 114 is not aligned with and is out of fluid communication with the first and second fixed housing bores 130,131, deemed a “closed” position, and a position shown in FIGS. 10 and 11, where the plate bore 118 is aligned with and is in fluid communication with the first and second fixed housing bores 130,131, deemed an “open” position. When the sliding plate valve assembly is operated to the open position a valve passage 124 is present, which allows for gas and fluid flow between the valve inlet gas passage 120 and the valve outlet gas passage 122. Additionally, when the sliding plate valve assembly 110 is in the open position, a seal can be formed between the plate 116 and the fixed housing 112 which does not allow gasses to escape into the plate cavity 117 or out of the fixed housing 112. When the sliding plate valve assembly 110 is in the closed position, the plate 116 can create a seal between the valve inlet gas passage 120 and the valve outlet gas passage 122, and allows for no or very minimal gas or fluid flow between the valve inlet gas passage 120 and the valve outlet gas passage 122.

The electric solenoid 142 can include a pushing solenoid that exerts an extending force outward along an axis of the pushing solenoid when energized, or a pulling solenoid that exerts a contracting force inward along an axis of the pulling solenoid when energized, or a rotary solenoid (not shown, but well known in the art). Examples of solenoids can include those described in U.S. Pat. No. 5,494,255, the disclosure of which is incorporated herein by reference.

The sliding plate valve assembly 110 can be powered by the electric solenoid 142 to move the plate 116 to the open position from the closed position and to the closed position from the open position. Optionally, a separate return spring or other mechanical means of biasing the sliding plate 116 to either the open position or the closed position can be employed, to optimize the power requirements of the electric solenoid 142 or reduce the transition time for movement of the sliding plate 116 between the open and closed positions.

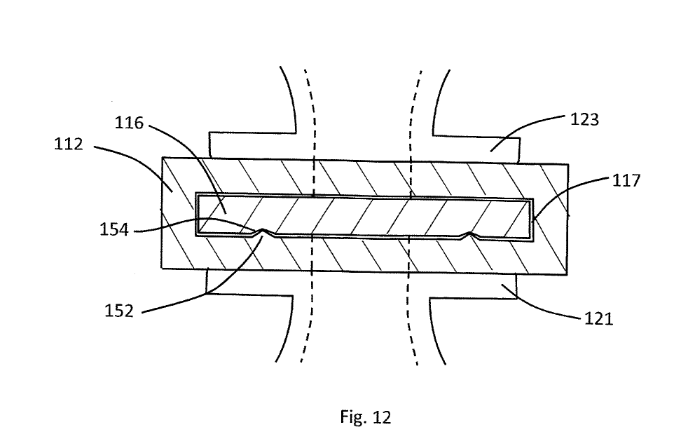

FIG. 12 shows an embodiment of a means for reducing contact surface between the sliding plate 116 and the housing 112. In this embodiment, the lower plate of the housing 112 includes a pair of parallel, spaced apart guide rails 152 disposed laterally on opposite sides of the inlet gas passage 120, extending along the length of the plate 116. The underside of the sliding plate 116 has a pair of parallel, spaced apart grooves 154 which register with the guide rails 152 to align and provide a reduced contact surface between the sliding plate 116 and the base of the housing 112 as the plate 116 reciprocates. Guide rails can also be disposed optionally on the upper side of the sliding plate 116.

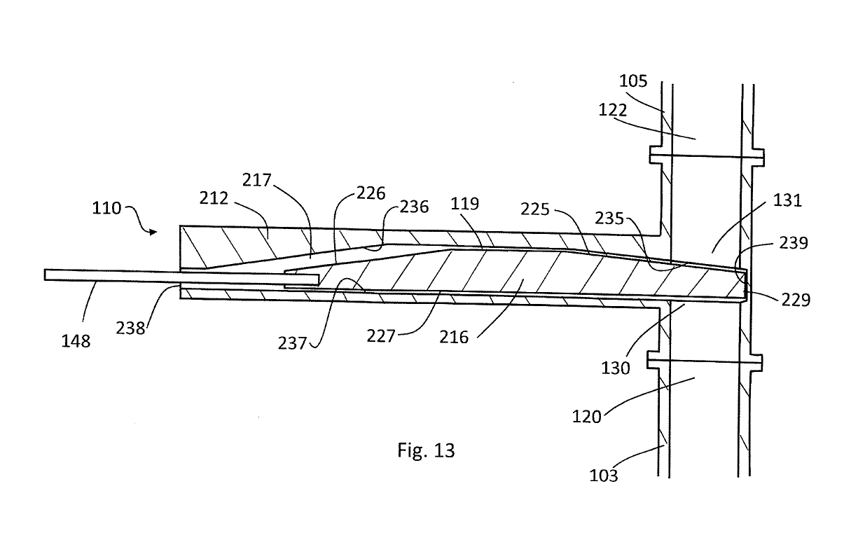

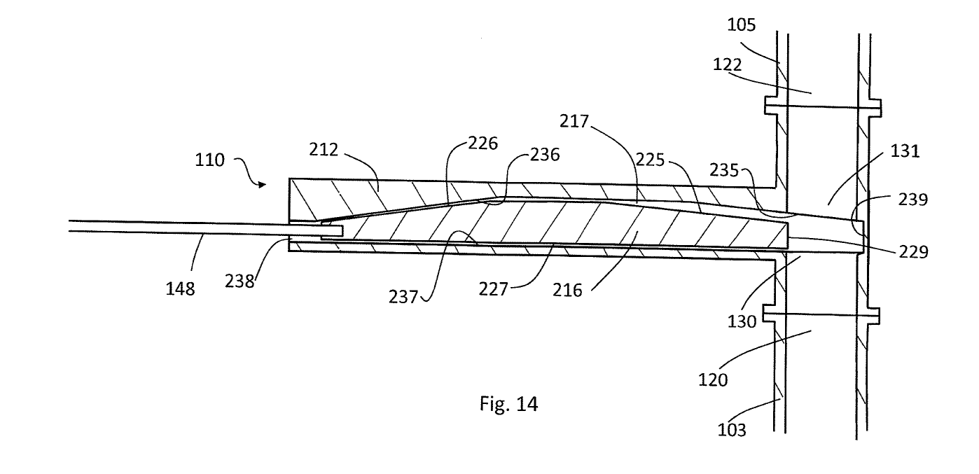

In another embodiment, shown in FIGS. 13 and 14, the plate 216 does not have a bore. In this embodiment, the plate 216 slides between a closed position where the plate 216 blocks air flow between the valve inlet gas passage 120 and the valve outlet gas passage 122, and an open position where the plate 216 does not block air flow between valve inlet gas passage 120 and valve outlet gas passage 122, and valve inlet gas passage 120 and valve outlet gas passage 122 are in fluid communication. The plate 216 and plate cavity 217 of the housing 212 can be contoured in complementary geometries. FIG. 13 shows the plate 216 in a closed stop position, wherein the sliding plate 216 seals closed the inlet air port 120. FIG. 14 shows the plate 216 in an opened stop position. FIG. 13 shows the housing 212 with a cavity 217, defined by a substantially planar bottom 237, a tapering forward upper surface 235, and a tapering rear upper surface 236. A shaped slot 239 is formed opposite the cavity 217 across the inlet air port 130. The plate 216 includes a substantially planar bottom 227, a front upper wall 225 that tapers to a lead edge 229 and conforms with the taper of the forward upper surface 235 of the cavity 217, and a rear upper wall 226 that conforms with the taper of the rear upper surface 236 of the cavity 217. In the closed position shown in FIG. 13, the lead edge 229 engages within the shaped slot 239 and seals the inlet air port 130 with the planar bottom 227, and the outlet air port 131 with the front upper wall 225. In the open position shown in FIG. 14, the leading edge 229 is withdrawn from the inlet/outlet air ports 130 and 131, while the planar bottom 227 and a rear upper wall 226 seal the rear portion of the cavity 217 to reduce and prevent air pressure loss through the rear opening 238.

In another similar embodiment, the plate 216 and the cavity 217 of the housing 212 are contoured on both the upper face and the lower face.

The fixed housing 112 may optionally include ball bearing(s) or a grease layer or another means for reducing friction and facilitating movement of the plate 116 within the plate cavity 117. The fixed housing or the plate, or both, can be fabricated from a ceramic matrix composite material or any other suitable material known in the art.

It shall be recognized that the drawings illustrating the invention are not intended to be to scale, or provide any limitation to the claimed invention in the size, shape, mass or design features of the sliding plate valve and its assembly. The sliding plate valve need not be any thicker, wider or longer, or of any particular shape, other than as necessary and suitable to cover the openings without air leakage.

In a method of the invention, the electric solenoid operates an air inlet and/a combustion air exhaust valve of a cylinder in the IC engine. In a two-stroke engine, the exhaust valve is closed during the compression, combustion and power phases of one complete cycle, and is open during the exhaust/air inlet phase. The exhaust valve can be in the open position for from one-third to two-thirds of a typical complete cycle. At typical engine speeds, one cycle is about 24 millisec, and the exhaust valve remains open from between 8-16 millisec. The electric solenoid is configured to move from an “off” or unpowered position, to an “on” or powered position with the arm extended, within 0.1-5 millisec. In one embodiment, during each engine cycle, a computer directs electrical power to the linear solenoid to open the rotary valve (the position shown in FIGS. 3 and 4) and remains powered for from 8 to about 16 millisec, and then removes electric power, to close the rotary valve (the position shown in FIGS. 1 and 2) for the time remaining in the cycle. The computer can also control and adjust the timing of the powering and unpowering of the rotary valve depending on the operating conditions of the engine, environmental and ambient operating conditions, type of fuel selected, and other parameters in order to optimize engine power output, fuel efficiency, or any other engine operating parameters. The timing of the rotary valve to begin opening or closing can be slaved to, or synchronized with, other parameters of the cylinder, such as the crank position of the piston, etc.

Similarly, in another method of the invention, the sliding plate valve assembly operates as an air inlet and/or a combustion air exhaust valve of a cylinder in the IC engine. In a two-stroke engine, the exhaust valve is closed during the compression, combustion and power phases of one complete cycle, and is open during the exhaust/air inlet phase. The exhaust valve can be in the open position for from one-third to two-thirds of a typical complete cycle. At typical engine speeds, one cycle is about 24 millisec, and the exhaust valve remains open from between 8-16 millisec. The electric solenoid can be configured to move from an “off” or unpowered position, to an “on” or powered position with the arm extended, within 0.1-5 millisec. In one embodiment, during each engine cycle, a computer directs electrical power to the linear solenoid to open the plate valve (the position shown in FIGS. 10, 11 and 14) and remains powered for from 8 to about 16 millisec, and then removes electric power, to close the plate valve (the position shown in FIGS. 8, 9, and 13) for the time remaining in the cycle. The computer can also control and adjust the timing of the powering and unpowering of the plate valve depending on the operating conditions of the engine, environmental and ambient operating conditions, type of fuel selected, and other parameters in order to optimize engine power output, fuel efficiency, or any other engine operating parameters. The timing of the plate valve to begin opening or closing can be slaved to, or synchronized with, other parameters of the cylinder, such as the crank position of the piston, etc.

1.-15. (canceled)

16. A sliding plate valve apparatus for a gas intake or exhaust piping for a cylinder of an internal combustion engine, the sliding plate valve apparatus comprising:
a. a planar plate having a body,
b. a fixed housing attached to a valve inlet gas pipe which defines a valve inlet gas passage and a valve outlet gas pipe which defines a valve outlet gas passage, the fixed housing having a plate cavity within which the plate can slide in a plane substantially perpendicular to the axes of the valve inlet gas passage and valve outlet gas passage, the fixed housing also having a first bore arranged in alignment with the valve inlet gas passage and second bore arranged in alignment with the valve outlet gas passage; and
c. an electric solenoid that reciprocates to move the plate within the plate cavity of the fixed housing between an open position wherein the plate body does not form a barrier between the valve inlet gas passage and the valve outlet gas passage to provide fluid communication therebetween, and a closed position wherein the plate body covers at least one of the valve inlet gas port and the valve outlet gas port, forming a barrier to fluid communication therebetween.

17. The sliding plate valve apparatus of claim 16, wherein the electric solenoid has a push arm that reciprocates along the axis of the push arm, and is mechanically attached to the plate.

18. The sliding plate valve apparatus of claim 17, wherein the solenoid is an electrical linear solenoid.

19. The sliding plate valve of claim 16, wherein the fixed housing or the plate or both are fabricated from ceramic matrix composite material.

20. A sliding plate valve apparatus for a gas intake or exhaust piping for a cylinder of an internal combustion engine, the sliding plate valve apparatus comprising:
a. a planar plate having a body and a plate bore,
b. a fixed housing attached to a valve inlet gas pipe which defines a valve inlet gas passage and to a valve outlet gas pipe which defines a valve outlet gas passage, the fixed housing having a plate cavity within which the plate can slide in a plane substantially perpendicular to the axes of the valve inlet gas passage and valve outlet gas passage, the fixed housing also having a first bore arranged in alignment with the valve inlet gas passage and second bore arranged in alignment with the valve outlet gas passage; and
c. an electric solenoid that reciprocates to move the plate within the plate cavity of the fixed housing between an open position wherein the plate bore is aligned with the first and second fixed housing bores and does not form a barrier between the valve inlet gas passage and the valve outlet gas passage to provide fluid communication therebetween, and a closed position wherein the plate body covers at least one of the valve inlet gas port and the valve outlet gas port, forming a barrier to fluid communication therebetween.

21. The sliding plate valve of claim 20, wherein the plate bore, the first fixed housing bore, and the second fixed housing bore have the same cross-sectional area and shape.

22. The sliding plate valve of claim 20, wherein the plate bore, the first fixed housing bore, the second fixed housing bore, the valve inlet gas passage, and the valve outlet gas passage have the same cross-sectional area and shape.

23. The sliding plate valve apparatus of claim 20, wherein the electric solenoid has a push arm that reciprocates along the axis of the push arm, and is mechanically attached to the plate.

24. The sliding plate valve of claim 20, wherein the solenoid is an electrical linear solenoid.

25. The sliding plate valve of claim 20, wherein the fixed housing or the plate or both are fabricated from ceramic matrix composite material.

26. A cylinder assembly of an internal combustion engine, including a sliding plate valve apparatus of claim 16.

27. A cylinder assembly of an internal combustion engine, including a sliding plate valve apparatus of claim 20.
